(19) United States
(12) Patent Application Publication
(10) Pub. No.: US 2023/0177032 A1
(43) Pub. Date: Jun. 8, 2023

(54) PERFORMING AUTOMATED SEMANTIC FEATURE DISCOVERY

(71) Applicant: International Business Machines Corporation, Armonk, NY (US)

(72) Inventors: Daniel Karl I. Weidele, Cambridge, MA (US); Lisa Amini, Weston, MA (US); Udayan Khurana, White Plains, NY (US); Kavitha Srinivas, Port Chester, NY (US); Horst Cornelius Samulowitz, Armonk, NY (US); Takaaki Tateishi, Yamato-shi (JP); Carolina Maria Spina, Buenos Aires (AR); Dakuo Wang, Cambridge, MA (US); Abel Valente, Buenos Aires (AR); Arunima Chaudhary, Dehradun (IN); Toshihiro Takahashi, Nakano-ku (JP)

(21) Appl. No.: 17/545,880

(22) Filed: Dec. 8, 2021

(51) Int. Cl. G06F 16/22; G06F 16/2457; G06F 16/28

(52) U.S. Cl. CPC G06F 16/221; G06F 16/2457; G06F 16/288; G06F 16/2282

(57) ABSTRACT

A computer-implemented method according to one embodiment includes identifying a data set and meta information; and augmenting the data set with additional features in response to an automatic analysis of the data set in view of the meta information.

### BACKGROUND

The present invention relates to data set analysis, and more particularly, this invention relates to dynamically performing semantic feature discovery on a data set.

The identification of valuable information (such as features of data) from data sets is of utmost importance in today's data-driven world. However, current methods for identifying such features are mostly manual, and rely on user-driven domain knowledge and a generalized application of transformation methods to a data set. There is therefore a need for a more dynamic and accurate automated approach when performing semantic feature discovery for a data set.

### BRIEF SUMMARY

A computer-implemented method according to one embodiment includes identifying a data set and meta information; and augmenting the data set with additional features in response to an automatic analysis of the data set in view of the meta information.

According to another embodiment, a computer program product includes one or more computer readable storage media, and program instructions collectively stored on the one or more computer readable storage media, the program instructions including instructions configured to cause one or more processors to perform a method including identifying, by the one or more processors, a data set and meta information; and augmenting, by the one or more processors, the data set with additional features in response to an automatic analysis of the data set in view of the meta information.

According to another embodiment, a system includes a processor; and logic integrated with the processor, executable by the processor, or integrated with and executable by the processor, where the logic is configured to identify a data set and meta information; and augment the data set with additional features in response to an automatic analysis of the data set in view of the meta information.

Other aspects and embodiments of the present invention will become apparent from the following detailed description, which, when taken in conjunction with the drawings, illustrate by way of example the principles of the invention.

### BRIEF DESCRIPTION OF THE DRAWINGS

FIG. 1 depicts a cloud computing environment in accordance with one aspect of the present invention.

FIG. 2 depicts abstraction model layers in accordance with one aspect of the present invention.

FIG. 3 depicts a cloud computing node in accordance with one aspect of the present invention.

FIG. 4 illustrates a tiered data storage system in accordance with one aspect of the present invention.

FIG. 5 illustrates a flowchart of a method for performing automated semantic feature discovery, in accordance with one aspect of the present invention.

FIG. 6 illustrates an exemplary semantic feature discovery environment, in accordance with one aspect of the present invention.

FIG. 7 illustrates an exemplary semantic feature discovery visualization, in accordance with one aspect of the present invention.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The following description discloses several aspects of performing automated semantic feature discovery.

In one general embodiment, a computer-implemented method includes identifying a data set and meta information; and augmenting the data set with additional features in response to an automatic analysis of the data set in view of the meta information.

In another general embodiment, a computer program product includes one or more computer readable storage media, and program instructions collectively stored on the one or more computer readable storage media, the program instructions including instructions configured to cause one or more processors to perform a method including identifying, by the one or more processors, a data set and meta information; and augmenting, by the one or more processors, the data set with additional features in response to an automatic analysis of the data set in view of the meta information.

In another general embodiment, a system includes a processor; and logic integrated with the processor, executable by the processor, or integrated with and executable by the processor, where the logic is configured to identify a data set and meta information; and augment the data set with additional features in response to an automatic analysis of the data set in view of the meta information.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

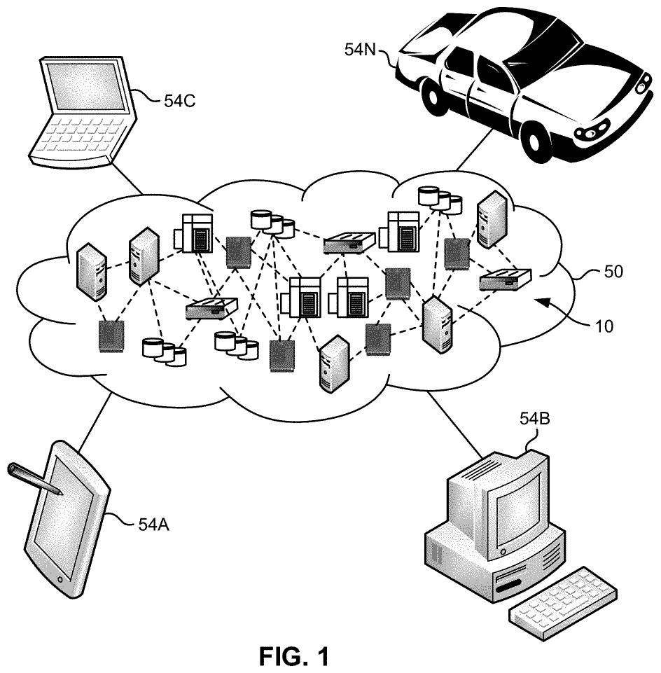

Referring now to FIG. 1, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 1 are intended to be illustrative only and that computing nodes 10 and cloud computing environment 50 can communicate with any type of computerized device over any type of network and/or network addressable connection (e.g., using a web browser).

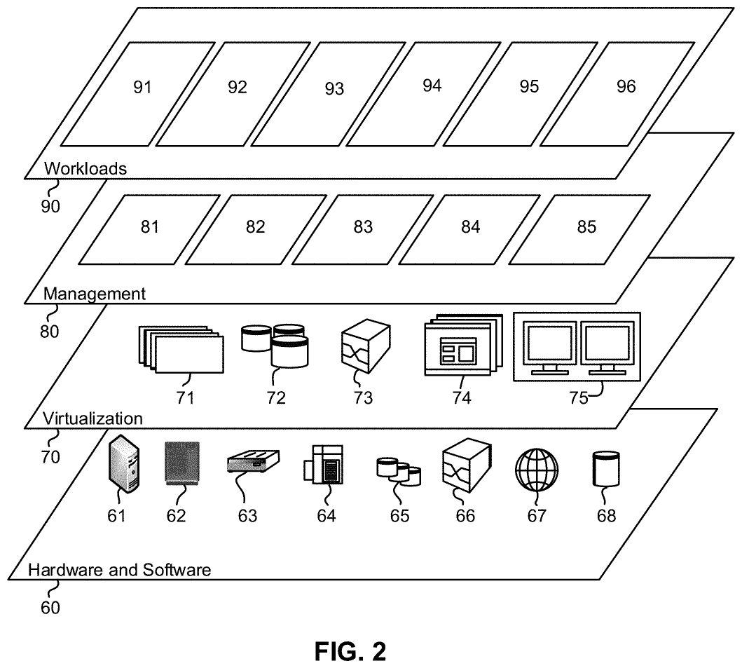

Referring now to FIG. 2, a set of functional abstraction layers provided by cloud computing environment 50 (FIG. 1) is shown. It should be understood in advance that the components, layers, and functions shown in FIG. 2 are intended to be illustrative only and aspects of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some aspects, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and semantic feature discovery 96.

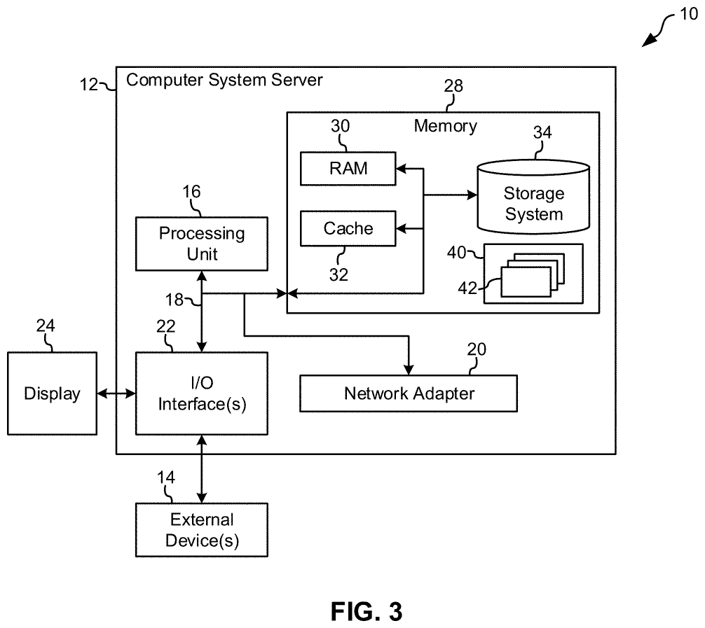

Referring now to FIG. 3, a schematic of an example of a cloud computing node is shown. Cloud computing node 10 is only one example of a suitable cloud computing node and is not intended to suggest any limitation as to the scope of use or functionality of aspects of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 3, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of aspects of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of aspects of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

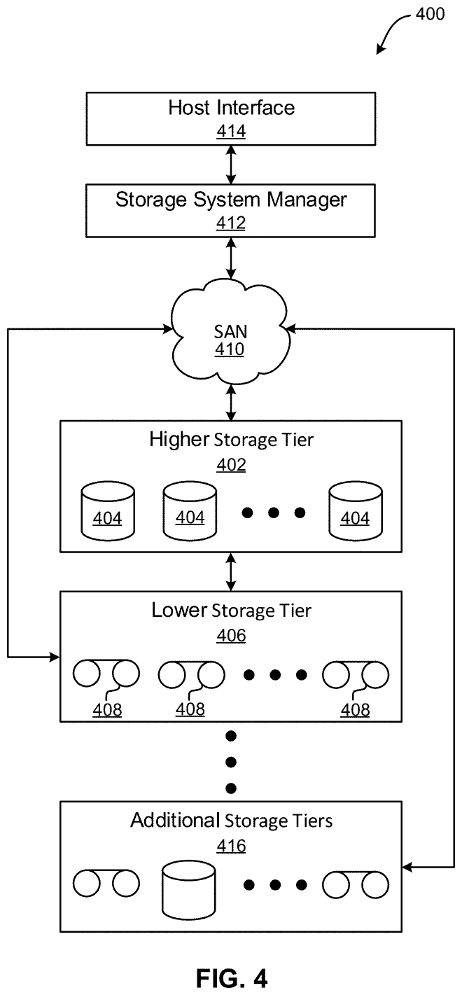

Now referring to FIG. 4, a storage system 400 is shown according to one aspect. Note that some of the elements shown in FIG. 4 may be implemented as hardware and/or software, according to various aspects. The storage system 400 may include a storage system manager 412 for communicating with a plurality of media on at least one higher storage tier 402 and at least one lower storage tier 406. The higher storage tier(s) 402 preferably may include one or more random access and/or direct access media 404, such as hard disks in hard disk drives (HDDs), nonvolatile memory (NVM), solid state memory in solid state drives (SSDs), flash memory, SSD arrays, flash memory arrays, etc., and/or others noted herein or known in the art. The lower storage tier(s) 406 may preferably include one or more lower performing storage media 408, including sequential access media such as magnetic tape in tape drives and/or optical media, slower accessing HDDs, slower accessing SSDs, etc., and/or others noted herein or known in the art. One or more additional storage tiers 416 may include any combination of storage memory media as desired by a designer of the system 400. Also, any of the higher storage tiers 402 and/or the lower storage tiers 406 may include some combination of storage devices and/or storage media.

The storage system manager 412 may communicate with the storage media 404, 408 on the higher storage tier(s) 402 and lower storage tier(s) 406 through a network 410, such as a storage area network (SAN), as shown in FIG. 4, or some other suitable network type. The storage system manager 412 may also communicate with one or more host systems (not shown) through a host interface 414, which may or may not be a part of the storage system manager 412. The storage system manager 412 and/or any other component of the storage system 400 may be implemented in hardware and/or software, and may make use of a processor (not shown) for executing commands of a type known in the art, such as a central processing unit (CPU), a field programmable gate array (FPGA), an application specific integrated circuit (ASIC), etc. Of course, any arrangement of a storage system may be used, as will be apparent to those of skill in the art upon reading the present description.

In more aspects, the storage system 400 may include any number of data storage tiers, and may include the same or different storage memory media within each storage tier. For example, each data storage tier may include the same type of storage memory media, such as HDDs, SSDs, sequential access media (tape in tape drives, optical disk in optical disk drives, etc.), direct access media (CD-ROM, DVD-ROM, etc.), or any combination of media storage types. In one such configuration, a higher storage tier 402, may include a majority of SSD storage media for storing data in a higher performing storage environment, and remaining storage tiers, including lower storage tier 406 and additional storage tiers 416 may include any combination of SSDs, HDDs, tape drives, etc., for storing data in a lower performing storage environment. In this way, more frequently accessed data, data having a higher priority, data needing to be accessed more quickly, etc., may be stored to the higher storage tier 402, while data not having one of these attributes may be stored to the additional storage tiers 416, including lower storage tier 406. Of course, one of skill in the art, upon reading the present descriptions, may devise many other combinations of storage media types to implement into different storage schemes, according to the aspects presented herein.

According to some aspects, the storage system (such as 400) may include logic configured to receive a request to open a data set, logic configured to determine if the requested data set is stored to a lower storage tier 406 of a tiered data storage system 400 in multiple associated portions, logic configured to move each associated portion of the requested data set to a higher storage tier 402 of the tiered data storage system 400, and logic configured to assemble the requested data set on the higher storage tier 402 of the tiered data storage system 400 from the associated portions.

Of course, this logic may be implemented as a method on any device and/or system or as a computer program product, according to various aspects.

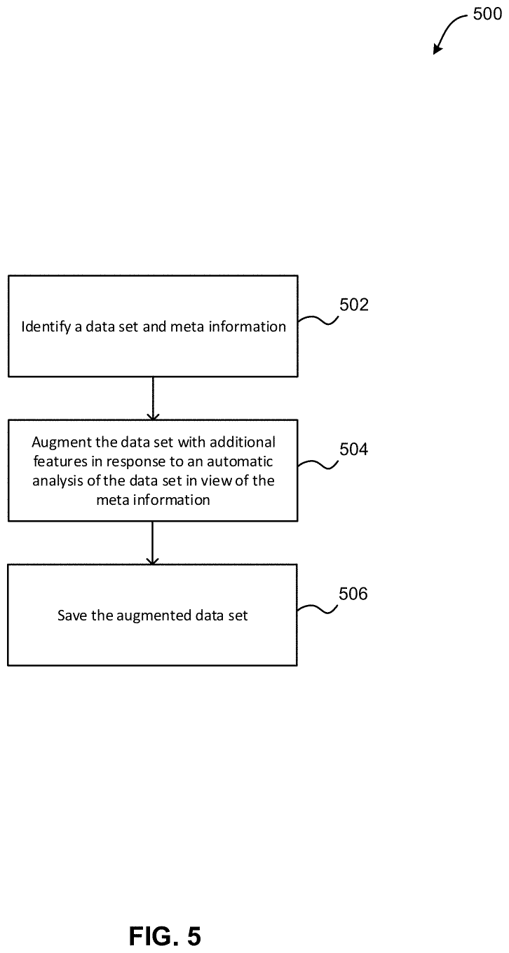

Now referring to FIG. 5, a flowchart of a method 500 is shown according to one aspect. The method 500 may be performed in accordance with the present invention in any of the environments depicted in FIGS. 1-4 and 6, among others, in various aspects. Of course, more or less operations than those specifically described in FIG. 5 may be included in method 500, as would be understood by one of skill in the art upon reading the present descriptions.

Each of the steps of the method 500 may be performed by any suitable component of the operating environment. For example, in various aspects, the method 500 may be partially or entirely performed by one or more servers, computers, or some other device having one or more processors therein. The processor, e.g., processing circuit(s), chip(s), and/or module(s) implemented in hardware and/or software, and preferably having at least one hardware component may be utilized in any device to perform one or more steps of the method 500. Illustrative processors include, but are not limited to, a central processing unit (CPU), an application specific integrated circuit (ASIC), a field programmable gate array (FPGA), etc., combinations thereof, or any other suitable computing device known in the art.

As shown in FIG. 5, method 500 may initiate with operation 502, where a data set and meta information are identified. In one embodiment, the data set may include a collection of data. In another embodiment, the data set may include one or more database tables. For example, each column of a table may represent a unique variable within the data set, and each row within the column may include a record/value for its associated variable.

Additionally, in one embodiment, the data set may be in a predetermined format (e.g., a comma separated value (CSV) file where each line within the file is a data record, etc.). In another embodiment, the meta information may include information used to enhance an analysis of the data set. In yet another embodiment, the meta information may include one or more data sources and/or knowledge bases.

For example, the meta information may include one or more documents, one or more audio/video files, one or more websites, one or more databases, one or more data libraries, one or more articles, etc. In another embodiment, the data sources and/or knowledge bases may be parsed and/or annotated.

Further, in one embodiment, the meta information may include one or more notebook documents. For example, each notebook document may include an analysis, description, and results of a previous data set analysis. In another example, each notebook document may include one or more equations, figures, links, executables, etc.

Further still, in one embodiment, the meta information may include one or more entities for transforming data within the data set. For example, the one or more entities may include one or more formulas, expressions, models, knowledge graphs, etc. In another example, the one or more entities may be extracted from other meta information (e.g., one or more data sources/knowledge bases, etc.).

Also, in one embodiment, the data set and/or the meta information may be submitted by a user (e.g., using a graphical user interface (GUI), etc. In another embodiment, the data set and/or the meta information may be dynamically identified and retrieved (e.g., via web crawling, automated retrieval, etc.).

In addition, method 500 may proceed with operation 504, where the data set is augmented with additional features in response to an automatic analysis of the data set in view of the meta information. In one embodiment, augmenting the data set may be performed after analyzing the data set in view of the meta information. In another embodiment, augmenting the data set may include applying one or more portions of the data set to one or more portions of the meta information (such as one or more extracted entities for transforming data) to obtain the additional features.

Furthermore, in one embodiment, each of the additional features may include metadata describing one or more characteristics and/or derived values within the data set. For example, each of the additional features may be added as a new column to the data set. In another embodiment, one or more entities for transforming data may be extracted from the meta information. For example, the meta information may be parsed to identify one or more formulas, expressions, models, knowledge graphs, etc. that are used within the meta information. In another example, extraction may be performed utilizing one or more of pipeline extraction, formula extraction, etc.

Further still, in one embodiment, the extracted entities for transforming data may be analyzed to determine entities that are applicable to data within the data set. For example, variables used within extracted entities (formulas, expressions, models, knowledge graphs, etc.) may be identified and compared to columns within the data set that represent unique variables within the data set to determine columns within the data set that match variables within the extracted entities. In another example, columns may be mapped to matching variables within the extracted entities.

Also, in one embodiment, one or more domain concepts (e.g., key words) may be identified within the data set (e.g., using semantic analysis, textual/audio/video parsing, etc.). For example, concept mapping may be performed to determine semantic concepts for each column within a data set. In another embodiment, a domain of the data set may be identified, and the columns within the data set may be analyzed in view of the meta information (such as previous data set analyses and associated results) to determine columns that are relevant to the domain of the data set. For example, historical data sets and associated concepts with similar signatures and patterns to the current data set may be determined and compared to the current data set to determine the relevant columns within the current data set.

Additionally, in one embodiment, each of the relevant columns may be analyzed in view of the meta information to determine an assigned concept for the column. For example, the concept for a column may include a textual description of the data within the column. In another embodiment, each of the relevant columns may be analyzed in view of the meta information to determine additional metadata for the column (e.g., contextual information, etc.).

Further, in one embodiment, portions of the data set and meta information, as well as the additional features, may be presented to one or more users for review and/or editing utilizing a visualization. For example, the visualization may be implemented utilizing a GUI. In another example, the data set may be presented as an icon within the visualization. In yet another example, identified domain concepts may be presented as a tag cloud within the visualization.

Further still, in one example, a graph may be provided within the implementation, where the data set icon forms the root of the graph and edges connect the data set icon to columns determined to be relevant to the domain of the data set. In another example, within the graph, edges may connect relevant columns to an assigned concept for the column, additional metadata for the column, etc. In yet another example, extracted entities for transforming data that are determined to be applicable to data within the data set may be presented for user review.

For instance, in response to user approval, one or more automatic and/or manual mappings may be created between variables used within extracted entities and columns within the data set. In another example, these mappings may be added as edges within the graph. In yet another example, utilizing the mappings, an entity may transform a portion of the data set to create a new feature and associated values.

Also, in one embodiment, any data presented to the user via the visualization may be adjusted on-demand in response to user input. For example, the user may update one or more of identified domain concepts, metadata, mappings, etc. In another embodiment, augmenting the data set may be performed by one or more trained machine learning models. For example, a machine learning model may be trained to identify entities for transforming data within meta information, identify columns within a data set that map to the variables within the entities, and automatically apply the data in the columns to the entities to create the additional features. In yet another embodiment, augmenting the data set may be performed in a distributed computing environment, in a cloud computing environment, etc.

In addition, method 500 may proceed with operation 506, where the augmented data set is saved. In one embodiment, the augmented data set may be stored as a knowledge base. In another embodiment, the augmented data set may be provided as additional meta information for the analysis of additional data sets. In yet another embodiment, components of the augmented data set may be displayed to one or more users via a GUI. For example, all features within the augmented data set may be identified and displayed. In another embodiment, the augmented data set may be provided as training data for a machine learning environment.

In this way, meta information may be used to provide insight during an analysis of a data set in order to dynamically determine additional features for that data set. This may provide more accurate and efficient feature identification when compared to previous brute-force transformation approaches, which may result in more valuable feature extraction, as well as a reduced amount of computing necessary to determined features for a data set, which may reduce an amount of processing required by computing hardware performing such feature determination, thereby improving a performance of such computing hardware.

Additionally, by using the augmented data set as meta information for the analysis of additional data sets, an amount of computing needed to be performed during that analysis may be decreased due to the additional features included within the augmented data set. This may reduce an amount of processing required by computing hardware performing such analysis, thereby improving a performance of such computing hardware.

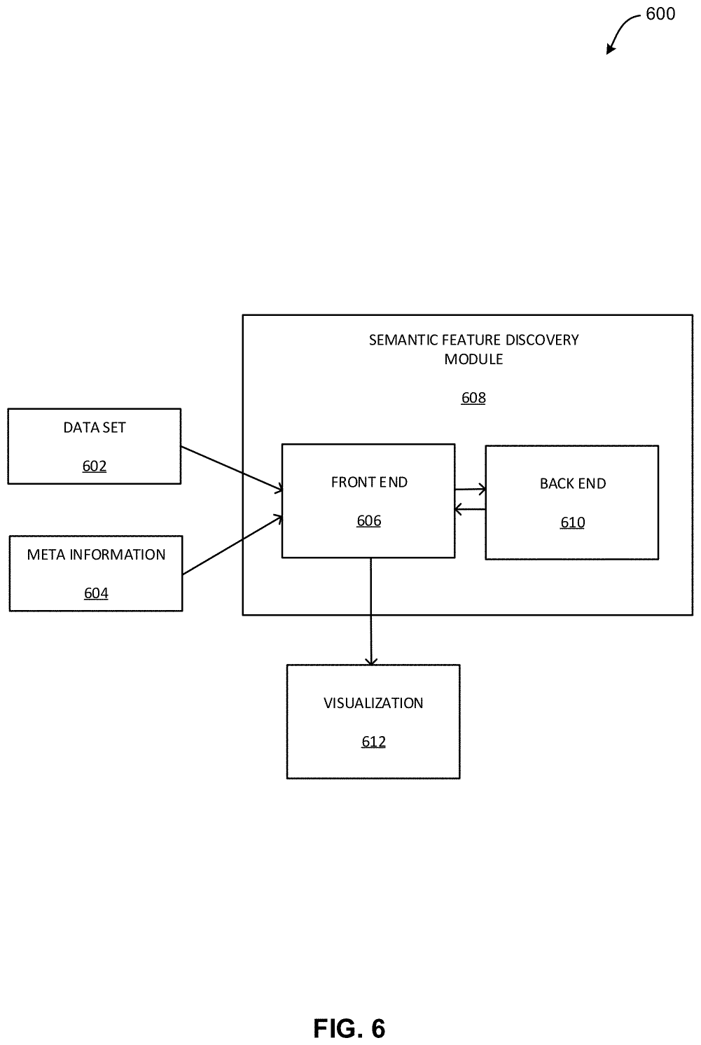

FIG. 6 illustrates an exemplary semantic feature discovery environment 600, according to one exemplary embodiment. As shown, a data set 602 and meta information 604 are input into a front end 606 of a semantic feature discovery module 608. For example, the front end 606 may utilize a GUI to facilitate the submission of the data set 602 and meta information 604 by a user and/or application.

Additionally, in one embodiment, the front end 606 may forward the data set 602 and meta information 604 to the back end 610 of the semantic feature discovery module 608. This may be done via a broadcasting process utilizing a message queue. In response to receiving the data set 602 and meta information 604, the back end 610 may perform an analysis of both the data set 602 and meta information 604.

For example, the back end 610 may call one or more additional modules to perform concept mapping of columns within the data set 602. Additionally, the back end 610 may call one or more additional modules to perform pipeline extraction and formula extraction on the meta information 604. The back end 610 may analyze the results of such calls in association with the data set 602 and meta information 604 to determine additional features for the data set 602.

Further, in one embodiment, portions of the data set 602 and meta information 604, as well as the additional features, may be presented to one or more users for review and/or editing via a visualization 612. In this way, the data set 602, meta information 604, and additional features, as well as their interrelationships, may be manually refined for improved accuracy.

As a result, the semantic feature discovery module 608 may dynamically determine additional features for a data set 602 via an analysis of the data set 602 in view of the provided meta information 604.

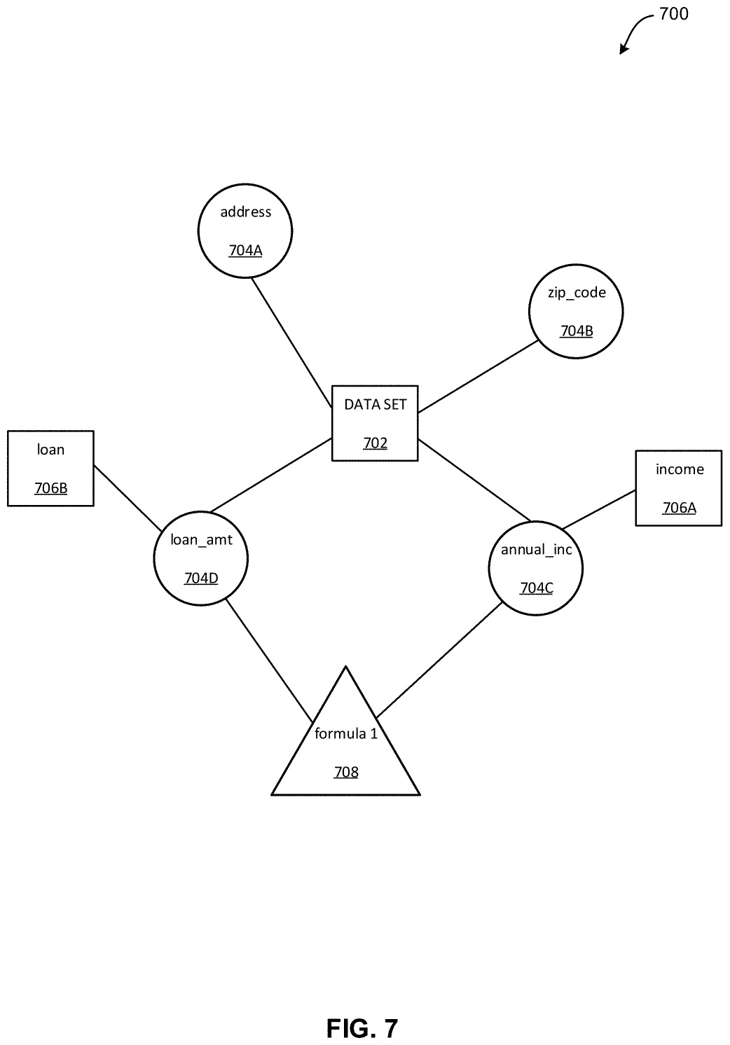

FIG. 7 illustrates an exemplary semantic feature discovery visualization 700, according to one exemplary embodiment. As shown, a data set icon 702 is displayed that is representative of an input data set being analyzed. Additionally, in one embodiment, a tag cloud may be presented around the data set icon 702.

Further, edges within the visualization 700 connect the data set icon 702 to columns 704A-D determined to be relevant to the domain of the data set icon 702. Also, additional edges connect a subset of the columns 704C-D to assigned concepts 706A-B, respectively.

Further still, an executable formula 708 may be applied to columns 704C-D. For example, each of the columns 704C-D may be mapped to a variable within the executable formula 708. The application of the executable formula 708 to the columns 704C-D may create an additional feature for the data set.

Also, in one embodiment, any of the above components of the visualization 700 may be user selectable and editable. This may enable a user to fine-tune the components of the data set utilizing the visualization 700 as a guide.

Visualization for Data Table Knowledge Graph and Interactive Feature Suggestion

Currently, feature engineering is mostly a human task. The existing automation is not driven semantically: it brute-forcedly applies candidate transformation methods to existing features in the dataset. Human-driven domain knowledge about a dataset may be used to generate new features (e.g., body height & weight can lead to BMI calculation). Current AI does not have a way to automatically generate features using domain knowledge.

In one embodiment, a visualization may be provided to interactively automate feature generation with human domain knowledge that can accelerate and improve the feature generation process standalone or as part of a process. In another embodiment, a system and visualization method may be provided to implement an architecture for interactive feature engineering that allows users to interact with the visualization for domain knowledge guided feature engineering, as well as visualizing the knowledge graph of a dataset.

Additionally, in one embodiment, a method is presented using a computing device for visualizing a knowledge graph and generating features for a table considering user input, the method comprising receiving by a computing device from a user the dataset and computed meta information; visualizing by the computing device with the dataset a graph display with columns in blue circles icon; and visualizing by the computing device the meta information in augmenting tag cloud and ambient graph display.

Further, the method comprises dispatching by the computing device to an Automated Knowledge-Augmented Feature Engineering Module for the dataset concept mapping; visualizing by the computing device the suggested candidate concepts for each of the feature/column in green diamond icon; and visualizing the selected concept for feature/column in green label icon.

Further still, the method comprises receiving by the computing device from the user an action of the suggested concepts; generating by the computing device the suggested new features using the selected concepts of the dataset; visualizing by the computing device the suggested new features in a red triangle icon; and saving the updated dataset with the new features to the various optimization modules inside the original data exploration system.

Also, in one embodiment, method of using a computing device to visualize knowledge graph features is provided, the method comprising receiving by a computing device from a user a dataset associated with a knowledge graph; generating by the computing device a graph displaying one or more features of the knowledge graph; providing by the computing device an interface to allow a user to view and interact with features of features of the knowledge graph via the graph; and modifying by the computing device the dataset and the associated knowledge graph based upon one or more interactions from the user.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some aspects, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to aspects of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various aspects of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Moreover, a system according to various aspects may include a processor and logic integrated with and/or executable by the processor, the logic being configured to perform one or more of the process steps recited herein. By integrated with, what is meant is that the processor has logic embedded therewith as hardware logic, such as an application specific integrated circuit (ASIC), a FPGA, etc. By executable by the processor, what is meant is that the logic is hardware logic; software logic such as firmware, part of an operating system, part of an application program; etc., or some combination of hardware and software logic that is accessible by the processor and configured to cause the processor to perform some functionality upon execution by the processor. Software logic may be stored on local and/or remote memory of any memory type, as known in the art. Any processor known in the art may be used, such as a software processor module and/or a hardware processor such as an ASIC, a FPGA, a central processing unit (CPU), an integrated circuit (IC), a graphics processing unit (GPU), etc.

It will be clear that the various features of the foregoing systems and/or methodologies may be combined in any way, creating a plurality of combinations from the descriptions presented above.

It will be further appreciated that aspects of the present invention may be provided in the form of a service deployed on behalf of a customer to offer service on demand.

The descriptions of the various aspects of the present invention have been presented for purposes of illustration, but are not intended to be exhaustive or limited to the aspects disclosed. Many modifications and variations will be apparent to those of ordinary skill in the art without departing from the scope and spirit of the described aspects. The terminology used herein was chosen to best explain the principles of the aspects, the practical application or technical improvement over technologies found in the marketplace, or to enable others of ordinary skill in the art to understand the aspects disclosed herein.

What is claimed is:

1. A computer-implemented method, comprising:
identifying a data set and meta information; and
augmenting the data set with additional features in response to an automatic analysis of the data set in view of the meta information.

2. The computer-implemented method of claim 1, wherein the data set includes one or more database tables, each column of the one or more database tables represent a unique variable within the data set, and each row within a column includes a record for its associated variable.

3. The computer-implemented method of claim 1, wherein the meta information includes one or more data sources and knowledge bases.

4. The computer-implemented method of claim 1, wherein the meta information includes one or more notebook documents, where each notebook document includes an analysis, description, and results of a previous data set analysis.

5. The computer-implemented method of claim 1, comprising extracting one or more entities for transforming data from the meta information.

6. The computer-implemented method of claim 1, comprising analyzing extracted entities for transforming data to determine entities that are applicable to data within the data set.

7. The computer-implemented method of claim 1, comprising:
identifying variables used within a model extracted from the meta information; and
comparing the variables to columns within the data set to determine columns within the data set that match the variables.

8. The computer-implemented method of claim 1, comprising:
identifying a domain of the data set; and
analyzing columns within the data set in view of the meta information to determine columns that are relevant to the domain of the data set.

9. The computer-implemented method of claim 1, comprising analyzing one or more columns of the data set in view of the meta information to determine an assigned concept for the column that includes a textual description of the data within the column.

10. The computer-implemented method of claim 1, comprising presenting portions of the data set and meta information, as well as the additional features, to one or more users for review and editing utilizing a visualization.

11. The computer-implemented method of claim 1, comprising providing the augmented data set as additional meta information for an analysis of additional data sets.

12. A computer program product comprising one or more computer readable storage media, and program instructions collectively stored on the one or more computer readable storage media, the program instructions comprising instructions configured to cause one or more processors to perform a method comprising:
identifying, by the one or more processors, a data set and meta information; and
augmenting, by the one or more processors, the data set with additional features in response to an automatic analysis of the data set in view of the meta information.

13. The computer program product of claim 12, wherein the data set includes one or more database tables, each column of the one or more database tables represent a unique variable within the data set, and each row within a column includes a record for its associated variable.

14. The computer program product of claim 12, wherein the meta information includes one or more data sources and knowledge bases.

15. The computer program product of claim 12, wherein the meta information includes one or more notebook documents, where each notebook document includes an analysis, description, and results of a previous data set analysis.

16. The computer program product of claim 12, comprising extracting, by the one or more processors, one or more entities for transforming data from the meta information.

17. The computer program product of claim 12, comprising analyzing, by the one or more processors, extracted entities for transforming data to determine entities that are applicable to data within the data set.

18. The computer program product of claim 12, comprising:
identifying, by the one or more processors, variables used within a model extracted from the meta information; and
comparing, by the one or more processors, the variables to columns within the data set to determine columns within the data set that match the variables.

19. The computer program product of claim 12, comprising:
identifying, by the one or more processors, a domain of the data set; and
analyzing, by the one or more processors, columns within the data set in view of the meta information to determine columns that are relevant to the domain of the data set.

20. A system, comprising:
a processor; and
logic integrated with the processor, executable by the processor, or integrated with and executable by the processor, the logic being configured to:
identify a data set and meta information; and
augment the data set with additional features in response to an automatic analysis of the data set in view of the meta information.
